(19) United States
(12) Patent Application Publication
(10) Pub. No.: US 2026/0087980 A1
(43) Pub. Date: Mar. 26, 2026

(54) DISPLAY DEVICE

(71) Applicant: LG Display Co., Ltd., Seoul (KR)

(72) Inventors: DongYoon Lee, Paju-si (KR); Seonghwan Hwang, Paju-si (KR); ByeongUk Gang, Paju-si (KR); HyunJin Kim, Paju-si (KR); Insu Hwang, Paju-si (KR); Jooyoung Pyo, Paju-si (KR)

(73) Assignee: LG Display Co., Ltd., Seoul (KR)

(21) Appl. No.: 19/340,442

(22) Filed: Sep. 25, 2025

(30) Foreign Application Priority Data
Sep. 26, 2024 (KR) 10-2024-0130893

(51) Int. Cl. G09G 3/3225

(52) U.S. Cl. CPC G09G 3/3225

(57) ABSTRACT

A display device including an active layer, a gate insulating film disposed on the active layer and having a first opening; a first electrode electrically connected to at least a portion of the first area in the first opening; a second electrode disposed on the gate insulating film; a protective layer disposed on the first electrode and the second electrode and having a second opening; and a pixel electrode disposed on the protective layer and electrically connected to the first electrode in the second opening.

### CROSS REFERENCE TO RELATED APPLICATION

This application claims priority from Korean Patent Application No. 10-2024-0130893, filed on Sep. 26, 2024, in the Republic of Korea, the contents of which are hereby incorporated by reference for all purposes as if fully set forth herein.

### BACKGROUND

### Technical Field

Embodiments of the present disclosure relate to a display device.

### Discussion of the Related Art

A display device can include at least a driving transistor and a storage capacitor for each sub-pixel. The display device can have sub-pixels with varying aperture ratios depending on the structure of different sub-pixels with the image quality or resolution of the display panel varying based on the aperture ratio of the sub-pixel. As resolution increases in display devices, it becomes useful to increase the aperture ratio of each sub-pixel.

However, since the number or type of elements (e.g., transistors, storage capacitors, light emitting device) included in each sub-pixel is limited, it can be difficult to optimize the sub-pixel structure to increase aperture ratio.

### SUMMARY OF THE DISCLOSURE

Embodiments of the present disclosure can provide a display device capable of reducing the size of the sub-pixel circuit portion provided in each sub-pixel through structural optimization.

Such embodiments can also provide a display device capable of reducing the size of the sub-pixel circuitry through structural optimization, thereby increasing the size of the aperture within each sub-pixel, improving light extraction efficiency, and reducing power consumption.

In addition, embodiments of the present disclosure can provide a display device capable of simplifying the structure of a sub-pixel circuit and reducing the size of a sub-pixel circuit by applying an overlapping structure of an opening in a protective layer and an opening in a gate insulating film to a sub-pixel circuit.

Such embodiments can also provide a display device capable of simplifying the structure of a sub-pixel circuit and reducing the size of a sub-pixel circuit by applying a non-overlapping structure of an opening of a protective layer and a storage capacitor to the sub-pixel circuit.

Additional embodiments can provide a display device in which a pixel electrode is electrically connected to an active layer with an electrode of a driving transistor interposed therebetween to form a current path within a sub-pixel circuit, thereby reducing contact resistance compared to a direct connection structure between the pixel electrode and the active layer.

Still further, embodiments of the present disclosure can provide a display device including a substrate, an active layer disposed on the substrate with the active layer including a channel area, a first area located on one side of the channel area, a second area located on the other side of the channel area. A gate insulating film can be disposed on the active layer and have a first opening. A first electrode can be electrically connected to at least a portion of the first area in the first opening, and a second electrode can be disposed on the gate insulating film and overlap the channel area. A protective layer can be disposed on the first electrode and the second electrode, overlap at least a portion of the first electrode, and have a second opening overlapping with at least a portion of the first opening. Further, a pixel electrode can be disposed on the protective layer and be electrically connected to the first electrode in the second opening.

Further embodiments of the present disclosure can provide a display device with a substrate and a driving transistor disposed on the substrate with the driving transistor including an active layer, a first electrode, a second electrode, and a third electrode. A light emitting device can include a pixel electrode electrically connected to the first electrode, a common electrode facing the pixel electrode, and a storage capacitor disposed on the driving transistor overlapping a channel area of the active layer of the driving transistor.

As described herein, it is possible to provide a display device capable of reducing the size of the sub-pixel circuit portion provided in each sub-pixel through structural optimization.

It is also possible to provide a display device capable of reducing the size of the sub-pixel circuitry through structural optimization, thereby increasing the size of the aperture within each sub-pixel, improving light extraction efficiency, and reducing power consumption.

It is still further possible to provide a display device capable of simplifying the structure of a sub-pixel circuit and reducing the size of a sub-pixel circuit by applying an overlapping structure of an opening in a protective layer and an opening in a gate insulating film to a sub-pixel circuit.

Thus, it is possible to provide a display device capable of simplifying the structure of a sub-pixel circuit and reducing the size of a sub-pixel circuit by applying a non-overlapping structure of an opening of a protective layer and a storage capacitor to the sub-pixel circuit.

It is also possible to provide a display device in which a pixel electrode is electrically connected to an active layer with an electrode of a driving transistor interposed therebetween to form a current path within a sub-pixel circuit, thereby reducing contact resistance compared to a direct connection structure between the pixel electrode and the active layer.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a diagram illustrating a display device according to embodiments of the present disclosure;

FIGS. 2 and 3 illustrate an example of a sub-pixel disposed in a display device according to embodiments of the present disclosure;

FIG. 4 illustrates another example of a sub-pixel of a display device according to embodiments of the present disclosure;

FIGS. 5 and 6 illustrate an implementation example of a sub-pixel according to embodiments of the present disclosure;

FIGS. 7 and 8 illustrate another implementation example of a sub-pixel according to embodiments of the present disclosure; and

FIGS. 9 and 10 illustrate another implementation example of a sub-pixel according to embodiments of the present disclosure.

### DETAILED DESCRIPTION OF THE EMBODIMENTS

In the following disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of various related/comparative functions and components incorporated herein will be omitted when it is determined that the description can make the subject matter in some embodiments of the present disclosure rather unclear.

Terms such as “including,” “having,” “containing,” “constituting,” “make up of,” and “formed of” used herein are generally intended to allow other components to be added unless the terms are used with the term “only.” As used herein, singular forms are intended to include plural forms unless the context clearly indicates otherwise.

In addition, the features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

In addition, terms such as “first,” “second,” “A,” “B,” “(A),” or “(B)” can be used herein to describe elements of the present disclosure. Each of these terms is not used to define essence, order, sequence, or number of elements, etc., but is used merely to distinguish the corresponding element from other elements.

When it is mentioned that a first element ‘is connected to,” “is coupled to,” “contacts,” “overlaps,” etc. a second element, it should be interpreted that, not only can the first element “be directly connected or coupled to” or “directly contact or overlap” the second element, but a third element can also be “interposed” between the first and second elements, or the first and second elements can “be connected to,” “be coupled to,” “contact,” “overlap”, etc. each other via a fourth element. Here, the second element can be included in at least one of two or more elements that “are connected to,” “are coupled to,” “contact,” “overlap,” etc. each other.

When time relative terms, such as “after,” “subsequent to,” “next,” “before,” and the like, are used to describe processes or operations of elements or configurations, or flows or steps in operating, processing, or manufacturing methods, these terms can be used to describe non-consecutive or non-sequential processes or operations unless the term “directly” or “immediately” is used together.

In addition, when any dimensions, relative sizes, etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “may” fully encompasses all the meanings of the term “can.”

Hereinafter, it will be described various embodiments of the disclosure in detail with reference to the accompanying drawings.

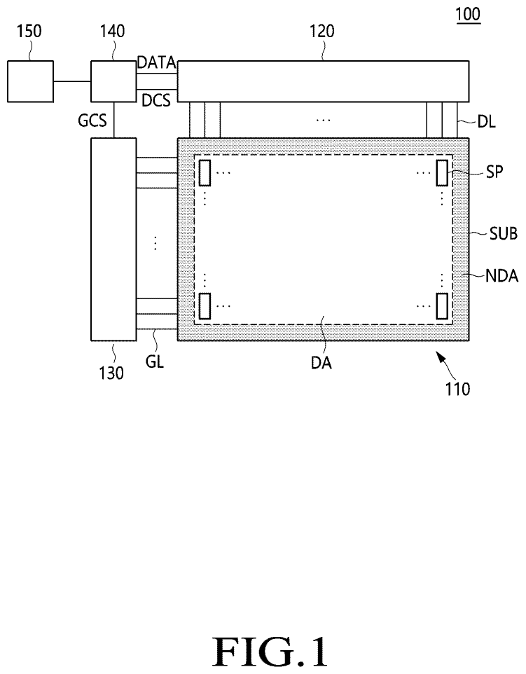

In particular, FIG. 1 is a diagram illustrating a display device 100 according to embodiments of the present disclosure.

Referring to FIG. 1, the display device 100 can include a display panel 110 and a driving circuit for driving the display panel 110.

As shown, the driving circuit can include a data driving circuit 120, a gate driving circuit 130, and a controller 140 for controlling the data driving circuit 120 and the gate driving circuit 130.

In addition, the display panel 110 can include a substrate SUB, a plurality of data lines DL, and a plurality of gate lines GL arranged on the substrate SUB. The display panel 110 can also include a plurality of sub-pixels SP connected to the data lines DL and the gate lines GL.

The display panel 110 can include a display area DA where an image is displayed and a non-display area NDA where an image is not displayed. In the display area DA of the display panel 110, the sub-pixels SP for displaying an image are disposed. In the non-display area NDA, the data driving circuit 120, the gate driving circuit 130, and the controller 140 can be electrically connected, or alternatively one or more of the data driving circuit 120, the gate driving circuit 130, and the controller 140 can be mounted, and a pad portion to which an integrated circuit or a printed circuit is connected can be disposed.

Further, the data driving circuit 120 is for driving the data lines DL, and can supply data signals to the data lines DL. The gate driving circuit 130 can be a circuit for driving the gate lines GL, and can supply a gate signal to the gate lines GL. The controller 140 can supply a data control signal DCS to the data driving circuit 120 to control the operation timing of the data driving circuit 120, can supply image data DATA to the data driving circuit 120, and can supply a gate control signal GCS to the gate driving circuit 130 to control the operation timing of the gate driving circuit 130.

Also, the controller 140 can receive input image data from an outside source (e.g., host system 150), scan the received input image data according to the timing implemented in each frame of received input image data, and convert the received input image data input from the outside into a data signal format used by the data driving circuit 120, supply image data DATA to the data driving circuit 120, and control the data driving at an appropriate time according to the scan of the received input image data.

Further, the controller 140 can output various gate control signals GCS including a gate start pulse (GSP), a gate shift clock (GSC), and a gate output enable signal (GOE) to control the gate driving circuit 130.

In addition, the controller 140 can output various data control signals DCS including a source start pulse (SSP), a source sampling clock (SSC), a source output enable signal (SOE) to control the data driving circuit 120.

The controller 140 can be implemented as a separate component from the data driving circuit 120, or can be implemented as an integrated circuit by being integrated with the data driving circuit 120.

Also, the data driving circuit 120 can receive image data DATA from the controller 140 and supply data voltages to a plurality of data lines DL, thereby driving the data lines DL. Here, the data driving circuit 120 can also be referred to as a source driving circuit.

In addition, the data driving circuit 120 can include at least one source driver integrated circuit (SDIC). For example, each source driver integrated circuit (SDIC) can be connected to the display panel 110 in a tape-automated-bonding (TAB) manner, can be connected to a bonding pad of the display panel 110 in a chip-on-glass (COG) or chip-on-panel (COP) manner, or can be implemented in a chip-on-film (COF) manner and connected to the display panel 110.

Further, the gate driving circuit 130 can output a gate signal of a turn-on voltage level or a gate signal of a turn-off voltage level according to the control of the controller 140. The gate driving circuit 130 can also sequentially drive a plurality of gate lines GL by sequentially supplying gate signals of a turn-on voltage level to a plurality of gate lines GL.

The gate driving circuit 130 can be connected to the display panel 110 in a tape-automated-bonding (TAB) manner, can be connected to a bonding pad of the display panel 110 in a chip-on-glass (COG) or chip-on-panel (COP) manner, or can be connected to the display panel 110 in a chip-on-film (COF) manner. Alternatively, the gate driving circuit 130 can be formed in a non-display area NDA of the display panel 110 as a gate-in-panel (GIP) type. In addition, the gate driving circuit 130 can be disposed on the substrate SUB or connected to the substrate SUB. If the gate driving circuit 130 is a GIP type device, the gate driving circuit 130 can be disposed in the non-display area NDA of the substrate SUB. The gate driving circuit 130 can also be connected to the substrate SUB if it is a chip-on-glass (COG) type, or a chip-on-film (COF) type.

In addition, at least one of the data driving circuit 120 and the gate driving circuit 130 can be disposed in the display area DA. For example, at least one of the data driving circuit 120 and the gate driving circuit 130 can be disposed so as not to overlap with the sub-pixels SP, or can be disposed to partially or completely overlap with the sub-pixels SP.

Continuing, for each specific gate line GL driven by the gate driving circuit 130, the data driving circuit 120 can convert the image data DATA received from the controller 140 into an analog data voltage and supply the converted image data to a plurality of data lines DL to activate individual sub pixels SP with a particular color and intensity. The data driving circuit 120 can be connected to one side (e.g., the upper side or the lower side) of the display panel 110. Depending on the driving method and the panel design method, the data driving circuit 120 can be connected to both sides (e.g., the upper side and the lower side) of the display panel 110, or can be connected to two or more of the four sides of the display panel 110.

Further, the gate driving circuit 130 can be connected to one side (e.g., the left side or the right side) of the display panel 110. Depending on the gate driving method and the panel design method, the gate driving circuit 130 can be connected to both sides (e.g., the left side and the right side) of the display panel 110, or can be connected to two or more of the four sides of the display panel 110.

Continuing, the display controller 140 can be a timing controller used in related/comparative examples of display technology, can be a control device capable of performing other control functions including a timing controller, can be a control device other than a timing controller, or can be a circuit within a control device. The controller 140 can be implemented with various circuits or electronic components such as an integrate circuit (IC), a Field Programmable Gate Array (FPGA), an Application Specific Integrated Circuit (ASIC), or a processor.

Also, the controller 140 can be mounted on a printed circuit board, a flexible printed circuit, etc. The controller 140 can also be electrically connected to the data driving circuit 120 and the gate driving circuit 130 through the printed circuit board, the flexible printed circuit, etc.

Further, the display device 100 can be a display including a backlight unit such as a liquid crystal display, or can be a self-luminous display such as an organic light emitting display, a quantum dot display, a micro light emitting diode (LED) display, etc. If the display device 100 is an organic light emitting display device, each sub-pixel SP can include an organic light emitting diode (OLED) capable of emitting light by itself as a light emitting device. If the display device 100 is a quantum dot display device, each sub-pixel SP can include a light emitting device made of a quantum dot, which is a semiconductor crystal emitting light by itself. If the display device 100 is a micro LED display, each sub-pixel SP can include a micro LED capable of emitting light by itself and is made of an inorganic material as a light emitting device.

The display panel 110 can have a top emission structure or a bottom emission structure, and in some cases, can have a double-sided emission structure.

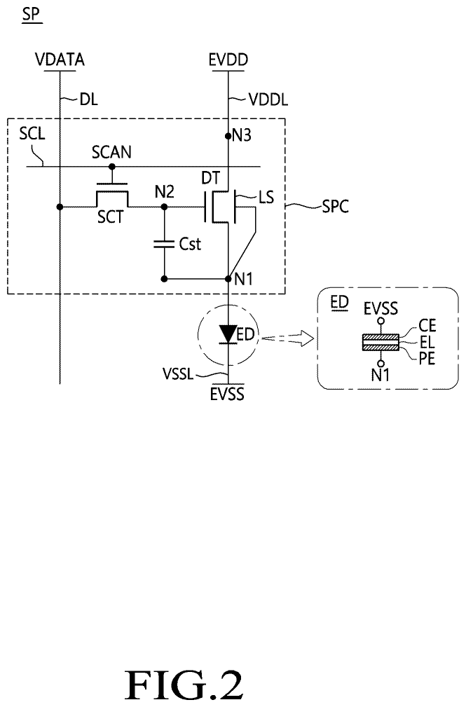

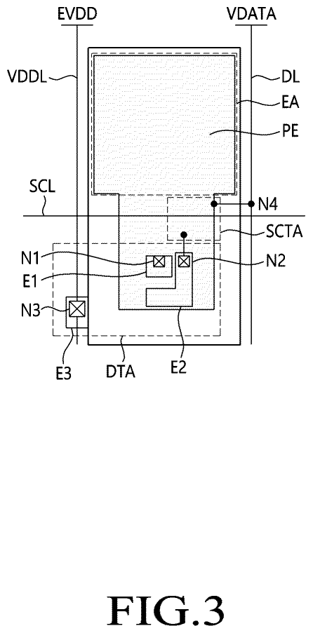

Next, FIGS. 2 and 3 illustrate an example of a sub-pixel SP disposed in a display device 100. Specifically, FIG. 2 illustrates an example of an equivalent circuit of a sub-pixel SP according to embodiments of the present disclosure, and FIG. 3 is a diagram for further explaining the equivalent circuit of the sub-pixel SP illustrated in FIG. 2.

Referring to FIG. 2, each sub-pixel SP can include a light emitting device ED and a sub-pixel circuit portion SPC configured to drive the light emitting device ED.

As is also shown in FIG. 2, the sub-pixel circuit SPC can include a driving transistor DT for driving a light emitting device ED, a scan transistor SCT for transmitting a data voltage VDATA to a first node N1 of the driving transistor DT, and a storage capacitor Cst between the first node N1 and a second node N2 for maintaining a constant voltage for one frame.

The light emitting device ED can include a pixel electrode PE and a common electrode CE, and an emission layer EL positioned between the pixel electrode PE and the common electrode CE.

Further, the pixel electrode PE of the light emitting device ED can be an electrode arranged for each sub-pixel SP, and the common electrode CE can be an electrode commonly arranged for all sub-pixels SP. Here, the pixel electrode PE can be an anode electrode, and the common electrode CE can be a cathode electrode. Alternatively, the pixel electrode PE can be a cathode electrode and the common electrode CE can be an anode electrode.

Also, the common electrode CE of the light emitting device ED can be connected to a low-potential voltage line VSSL applying a low-potential voltage EVSS.

The light emitting device ED can be, for example, an organic light-emitting diode (OLED), a light-emitting diode (LED), or a quantum dot light emitting device.

In addition, the driving transistor DT is for driving the light emitting device ED, and can include the first node N1, the second node N2, a third node N3, and the like.

The first node N1 of the driving transistor DT can be a source node or a drain node of the driving transistor DT and can be electrically connected to the pixel electrode PE of the light emitting device ED.

The second node N2 of the driving transistor DT can be the gate node of the driving transistor DT and can be electrically connected to the source node or drain node of the scan transistor SCT.

The third node N3 of the driving transistor DT can be the drain node or source node of the driving transistor DT and can be electrically connected to a high-potential voltage line VDDL supplying a high-potential power supply voltage EVDD.

In addition, the driving transistor DT can have unique characteristics such as threshold voltage and mobility. If the unique characteristics of the driving transistor DT change, the current driving capability (e.g., current supply performance) of the driving transistor DT changes, and the emission characteristics of the corresponding sub-pixel SP can also change.

The device characteristics (e.g., threshold voltage, mobility, etc.) of the driving transistor DT can change as the driving time of the driving transistor DT elapses. In addition, if light is irradiated on the driving transistor DT, especially if light is irradiated on the channel area of the driving transistor DT, the device characteristics (e.g., threshold voltage, mobility, etc.) of the driving transistor DT can change.

Therefore, as illustrated in FIG. 2, a shielding pattern LS can be formed near the driving transistor DT in order to reduce a change in the device characteristic (e.g., threshold voltage changes, mobility changes, etc.) of the driving transistor DT. For example, the shielding pattern LS can be formed under the active layer of the driving transistor DT.

In addition to the light blocking role, the shielding pattern LS can be formed under the channel area of the driving transistor DT, and can serve as a functional part of the driving transistor DT.

As a result, the shielding pattern LS can shield the driving transistor DT against light, e.g., reduce the reflection of external light when the display panel 110 is a bottom emission structure, but also influence the electric field of a channel area of the driving transistor DT when the shielding pattern LS, is electrically connected to the first node N1 of the driving transistor DT.

In addition, the scan transistor SCT can be controlled by a scan gate signal SCAN, which is a type of gate signal, and can be connected between the second node N2 of the driving transistor DT and the data line DL.

As a result, the scan transistor SCT can be turned on or off according to the scan gate signal SCAN supplied through a scan gate line SCL, which is a type of gate line GL, to control the connection between the data line DL and the second node N2 of the driving transistor DT.

In addition, the scan transistor SCT can be turned on by a scan gate signal SCAN having a turn-on level voltage, and can transmit the data voltage VDATA supplied from the data line DL to the second node N2 of the driving transistor DT.

Here, if the scan transistor SCT is an n-type transistor, the turn-on level voltage of the scan gate signal SCAN can be a high-level voltage. If the scan transistor SCT is a p-type transistor, the turn-on level voltage of the scan gate signal SCAN can be a low-level voltage.

Further, the storage capacitor Cst can be connected between the first node N1 and the second node N2 of the driving transistor DT. The storage capacitor Cst can also be charged with a charge amount corresponding to the voltage difference between the two terminals, and can play a role of maintaining the voltage difference between the two terminals for a set frame time. Accordingly, the corresponding sub-pixel SP can emit light during a given frame time.

Referring to FIGS. 2 and 3, a sub-pixel SP can include an emission area (i.e., an opening, EA) in which a light emitting device ED is disposed, and a sub-pixel circuit SPC in which a driving transistor DT and a scan transistor SCT are disposed. Here, the sub-pixel circuit SPC can include a scan transistor area SCTA in which a scan transistor SCT is disposed, and a driving transistor area DTA in which a driving transistor DT is disposed.

As shown, a first electrode E1, a second electrode E2, and a third electrode E3 of the driving transistor DT can be disposed in the driving transistor area DTA.

For example, the first electrode E1 can be a source electrode or a drain electrode of the driving transistor DT, the second electrode E2 can be a gate electrode of the driving transistor DT, and the third electrode E3 can be a drain electrode or a source electrode of the driving transistor DT.

Referring to FIG. 3, the third electrode E3 disposed in the driving transistor area DTA can overlap with a high-potential voltage line VDDL, and the third electrode E3 can be electrically connected to the high-potential voltage line VDDL at a position overlapping with the high-potential voltage line VDDL.

Accordingly, the third electrode E3 can be disposed on the high-potential voltage line VDDL, and can be electrically connected to the high-potential voltage line VDDL.

Referring to FIG. 2 and FIG. 3, the light emitting device ED disposed in the emission area EA can include a pixel electrode PE, an emission layer EL, and a common electrode CE. Here, the pixel electrode PE can extend from the emission area EA in the direction of the driving transistor area DTA and overlap with the first electrode E1 and the second electrode E2 of the driving transistor DT.

In addition, the driving transistor area (DTA) can be formed with an opening overlap structure in which the opening of the protective layer and the opening of the gate insulating film overlap, thereby simplifying the structure of the sub-pixel circuit SPC and reducing the size of the sub-pixel circuit SPC.

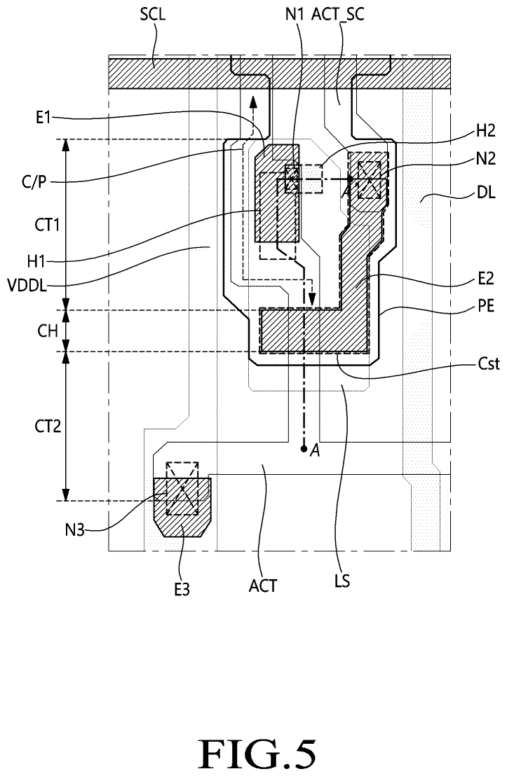

An opening overlapping structure applied to the sub-pixel circuit SPC will be specifically described later with reference to FIGS. 5 to 10.

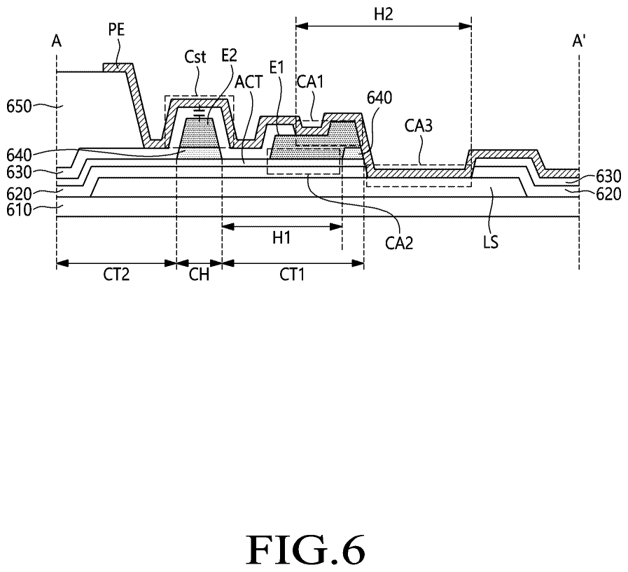

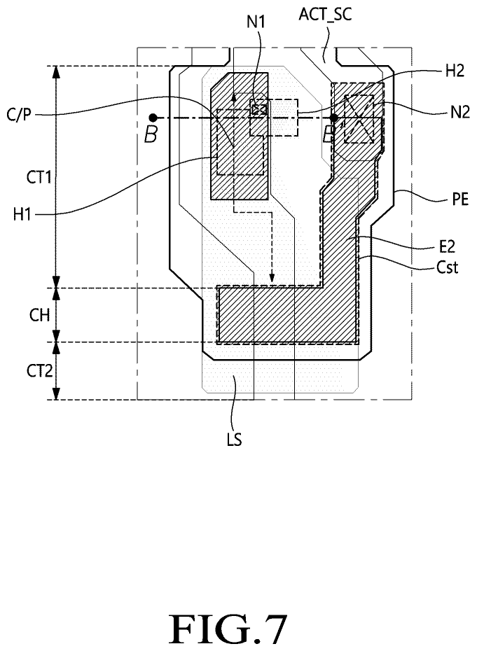

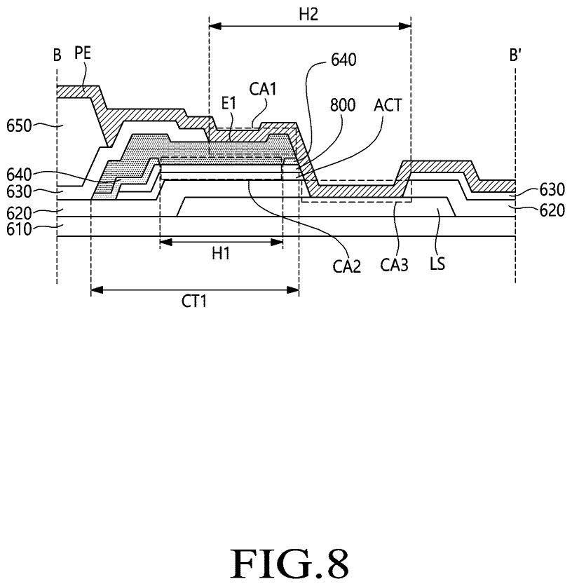

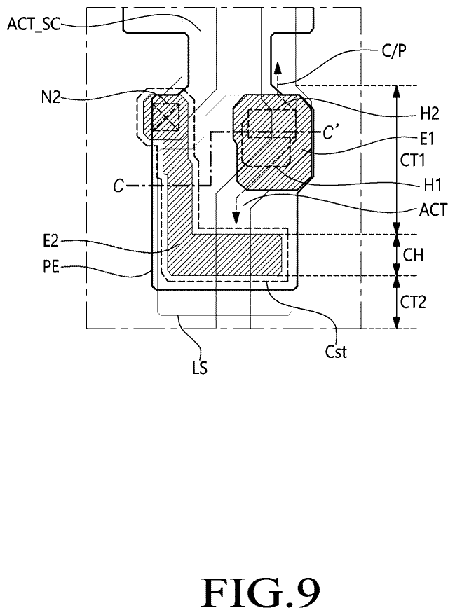

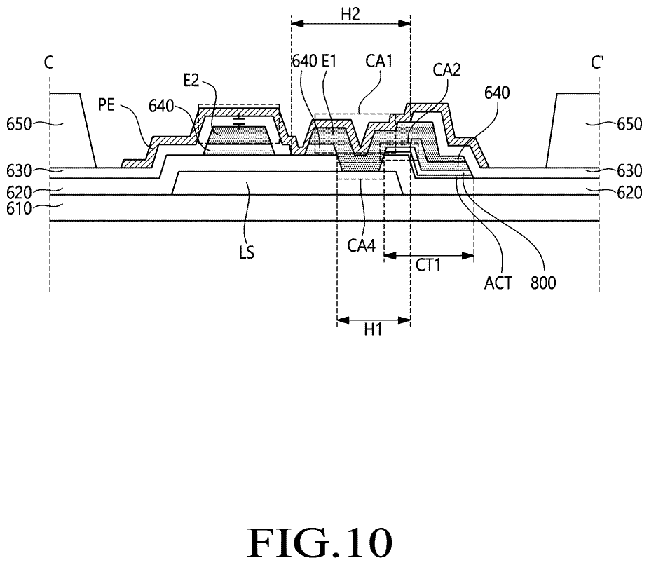

For reference, FIGS. 5 and 6 illustrate one implementation example of a sub-pixel SP, FIGS. 7 and 8 illustrate another implementation example of a sub-pixel SP, and FIGS. 9 and 10 illustrate another implementation example of a sub-pixel SP. However, the embodiments of the present disclosure are not limited thereto, and the configurations described below with reference to FIGS. 5 to 10 can also be applied as a single implementation example of a sub-pixel SP.

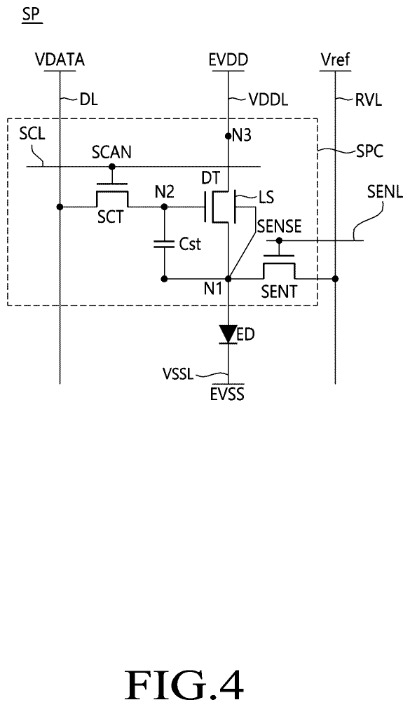

Next, FIG. 4 illustrates another example of a sub-pixel SP of a display device 100.

Specifically, FIG. 4 illustrates another example of an equivalent circuit of a sub-pixel SP according to embodiments of the present disclosure. As shown in FIG. 4, each of a plurality of sub-pixels SP disposed on a display panel 110 of a display device 100 can further include a sensing transistor SENT.

In addition, the sensing transistor SENT can be controlled by a sensing gate signal SENSE, which is a type of gate signal, and can be connected between a first node N1 of a driving transistor DT and a reference voltage line RVL. In other words, the sensing transistor SENT can be turned on or off according to the sensing gate signal SENSE supplied from the sensing gate line SENL, which is another type of gate line GL, to control the connection between the reference voltage line RVL and the first node N1 of the driving transistor DT.

Also, the sensing transistor SENT can be turned on by a sensing gate signal SENSE having the turn-on level voltage, and can transmit a reference voltage Vref supplied from the reference voltage line RVL to the first node N1 of the driving transistor DT.

In addition, the sensing transistor SENT can be turned on by the sensing gate signal SENSE having the turn-on level voltage, and can transmit the voltage of the first node N1 of the driving transistor DT to the reference voltage line RVL.

Here, if the sensing transistor SENT is an n-type transistor, the turn-on level voltage of the sensing gate signal SENSE can be a high-level voltage. If the sensing transistor SENT is a p-type transistor, the turn-on level voltage of the sensing gate signal SENSE can be a low-level voltage.

The function of the sensing transistor SENT to transfer the voltage of the first node N1 of the driving transistor DT to the reference voltage line RVL can be used when driving to sense the characteristic value of the sub-pixel SP. In this situation, the voltage transferred to the reference voltage line RVL can be a voltage for calculating the characteristic value of the sub-pixel SP or a voltage in which the characteristic value of the sub-pixel SP is reflected.

Also, each of the driving transistor DT, the scan transistor SCT, and the sensing transistor SENT can be an n-type transistor or a p-type transistor. In the embodiments of the present disclosure, for convenience of explanation, each of the driving transistor DT, the scan transistor SCT, and the sensing transistor SENT of the current example is n-type.

In addition, the storage capacitor Cst can be an external capacitor intentionally designed to be outside the driving transistor DT, rather than a parasitic capacitor, such as an internal capacitor existing between the gate node and the source node (Cgs) of the driving transistor DT and an internal capacitor existing between the gate node and the drain node (Cgd) of the driving transistor DT.

In addition, the scan gate line SCL and the sensing gate line SENL can be different gate lines GL. In this situation, the scan gate signal SCAN and the sensing gate signal SENSE can be separate gate signals, and the on-off timing of the scan transistor SCT and the on-off timing of the sensing transistor SENT in one sub-pixel SP can be independent. The on-off timing of the scan transistor SCT and the on-off timing of the sensing transistor SENT in one sub-pixel SP can be the same or different.

Alternatively, the scan gate line SCL and the sensing gate line SENL can be the same gate line GL, and a gate node of the scan transistor SCT and a gate node of the sensing transistor SENT in one sub-pixel SP can be connected to one gate line GL. In this situation, the scan gate signal SCAN and the sensing gate signal SENSE can be the same gate signal, and the on-off timing of the scan transistor SCT in one sub-pixel SP and the on-off timing of the sensing transistor SENT in one sub-pixel SP can be the same.

The structure of the sub-pixel SP illustrated in FIGS. 2 and 4 is only an example, and can be variously modified to include one or more transistors or one or more capacitors.

Next, FIGS. 5 and 6 are diagrams illustrating another implementation example of a sub-pixel SP.

Specifically, FIG. 5 illustrates a plan view according to an implementation example of a driving transistor area DTA provided in a sub-pixel SP, and FIG. 6 illustrates a cross-sectional view of the driving transistor area DTA along the line A-A′ illustrated in the plan view of FIG. 5.

Referring to FIGS. 5 and 6, an example sub-pixel SP can include a substrate 610, a shielding pattern LS disposed on the substrate 610, a buffer layer 620 disposed on the substrate 610 and the shielding pattern LS, and an active layer ACT disposed on the buffer layer 620.

The sub-pixel SP can further include a gate insulating film 640 disposed on the active layer ACT, a first electrode E1, a second electrode E2 disposed to overlap with at least a portion of the gate insulating film 640, a protective layer 630 disposed on the first electrode E1 and the second electrode E2, and a pixel electrode PE of a light emitting device ED disposed on the protective layer 630.

In addition, the sub-pixel SP can further include an overcoat layer 650 disposed on the protective layer 630.

The active layer ACT can include a channel area CH, a first area CT1 located on one side of the channel area CH, and a second area CT2 located on the other side of the channel area CH.

The active layer ACT can be implemented as a single-film structure, and in this situation, the active layer ACT can include at least one material among Indium Gallium Zinc Oxide (IGZO) and Indium Zinc Oxide (IZO), but the embodiments of the present disclosure are not limited thereto.

Also, the sub-pixel SP can further include an auxiliary electrode disposed between the active layer ACT and the first electrode E1, and the auxiliary electrode can include a transparent conductive oxide.

For example, the transparent conductive oxide can include at least one of Indium Zinc Oxide (IZO), Indium Tin Oxide (ITO), Indium-Gallium-Zinc Oxide (IGZO), Zinc Oxide (ZnO), Aluminum-doped Zinc Oxide (AZO), Gallium-doped Zinc Oxide (GZO), Antimony Tin Oxide (ATO), and Fluorine-doped Transparent Oxides (FTO).

By way of additional example. if an auxiliary electrode is disposed between the active layer ACT and the first electrode E1, one of the active layer ACT and the auxiliary electrode can include an Indium Gallium Zinc Oxide (IGZO) material, and the other can include an Indium Zinc Oxide (IZO) material. However, the embodiments of the present disclosure are not limited thereto.

If the auxiliary electrode is not disposed, the active layer ACT can be an active layer in which at least a portion of the active layer ACT is conductive. For example, the active layer ACT can be conductive in at least a portion of the remaining area except for an area overlapping with the channel area CH, but the embodiments of the present disclosure are not limited thereto.

Further, the gate insulating film 640 can include a first opening H1, and the first electrode E1 can be electrically connected to at least a portion of the first area CT1 of the active layer ACT in the first opening H1.

Accordingly, the first opening H1 of the gate insulating film 640 can include a second connection portion CA2 in which the first electrode E1 and the first area CT1 of the active layer ACT are electrically connected.

In addition, the first electrode E1 can be disposed to be electrically connected to the first area CT1, and can be disposed to overlap with a portion of the gate insulating film 640. For example, the first electrode E1 can be a source electrode or a drain electrode of the driving transistor DT. The second electrode E2 can be disposed on the gate insulating film 640, and can overlap with the channel area CH. Thus, the second electrode E2 can be a gate electrode of the driving transistor DT.

The protective layer 630 can include a second opening H2 overlapping with at least a portion of the first electrode E1 and overlaps with at least a portion of the first opening H1.

Also, the pixel electrode PE can be electrically connected to the first electrode E1 at the second opening H2, and can be electrically connected to the shielding pattern LS at the second opening H2.

Accordingly, the second opening H2 can include a first connection portion CA1 through which the pixel electrode PE and the first electrode E1 are electrically connected, and a third connection portion CA3 through which the pixel electrode PE and the shielding pattern LS are electrically connected.

Further, in a single opening of the protective layer 630 (e.g., in the second opening H2), the pixel electrode PE can be electrically connected to the first electrode E1 and the shielding pattern LS simultaneously.

As at least a portion of the first opening H1 and at least a portion of the second opening H2 overlap with each other, and at least a portion of the first connection portion CA1 and at least a portion of the second connection portion CA2 can also overlap with each other.

Through the first connection portion CA1, the second connection portion CA2, and the third connection portion CA3, the pixel electrode PE, the first electrode E1, the first area CT1 of the active layer ACT, and the shielding pattern LS can be electrically connected to each other to form one node, i.e., the first node N1.

For example, a node formed by a pixel electrode PE, a first electrode E1, a first area CT1 of an active layer ACT, and a shielding pattern LS can be a source node of a driving transistor DT, but the embodiments of the present disclosure are not limited thereto.

The second opening H2 may not overlap with a storage capacitor Cst disposed in each of a plurality of sub-pixels SP, and a node formed by a pixel electrode PE, a first electrode E1, a first area CT1 of an active layer ACT, and a shielding pattern LS may not overlap with a storage capacitor Cst.

Referring to FIGS. 5 and 6, the storage capacitor Cst can overlap with a channel area CH, which can include a gate node (i.e., the second node N2) of the driving transistor DT.

The second electrode E2 can be any one of the capacitor electrodes constituting the storage capacitor Cst, and the pixel electrode PE can be another one of the capacitor electrodes constituting the storage capacitor Cst.

Specifically, the storage capacitor Cst can include the second electrode E2 as a first capacitor electrode, the pixel electrode PE adjacent to the second electrode E2 as a second capacitor electrode. In addition, the protective layer 630 provided between the first capacitor electrode and the second capacitor electrode can be included as an insulator of the storage capacitor Cst.

Referring to FIGS. 5 and 6, the active layer ACT can include peripheral area of a first connection portion CA1 provided in the second opening H2 and a second connection portion CA2 provided in the first opening H1. In addition, a current path (C/P) in the active layer ACT can be formed in the peripheral area.

Accordingly, the vertically overlapping pixel electrode PE and the active layer ACT may not be directly connected, but be connected to each other through the first electrode E1, thereby forming a current path (C/P) of the active layer ACT around the first opening H1 and the second opening H2. Accordingly, it is possible to reduce the size of the sub-pixel circuit SPC and prevent a driving failure due to high contact resistance caused when the pixel electrode PE and the active layer ACT are directly connected.

Referring to FIG. 5, the second electrode E2 overlapping with the channel area CH of the active layer ACT can extend to an area not overlapping with the active layer ACT, and can be electrically connected to the source electrode or drain electrode ACT_SC of the scan transistor SCT. For convenience of explanation, the reference number ‘ACT_SC’ can be described as the source electrode of the scan transistor SCT.

The sub-pixel SP of FIG. 5 can further include a third electrode E3 extending to an area in which the second area CT2 of the active layer ACT and the high-potential voltage line VDDL are formed, and overlapping with the high-potential voltage line VDDL and the second area CT2.

The third electrode E3 can be electrically connected to at least a portion of the high-potential voltage line VDDL and at least a portion of the second area CT2 of the active layer ACT on the high-potential voltage line VDDL. Accordingly, a high-potential power supply voltage EVDD can be applied to the second area CT2 through the high-potential voltage line VDDL. The third electrode E3 can be a drain electrode or a source electrode of a driving transistor. If an auxiliary electrode is disposed between the active layer ACT and the first electrode E1, an auxiliary electrode can also be disposed between the active layer ACT and the third electrode E3.

According to the example of FIG. 5, the high-potential voltage line VDDL and the data line DL can be formed of the same material as the shielding pattern LS.

In addition, the scan gate line SCL and the first electrode E1, the second electrode E2, and the third electrode (E3) of the driving transistor DT can be formed of the same material. Still further, the active layer ACT of the driving transistor DT and the source electrode ACT_SC of the scan transistor SCT can be formed of the same material.

Next, FIGS. 7 and 8 are diagrams illustrating other implementation examples of a sub-pixel SP.

Specifically, FIG. 7 is a plan view according to another embodiment of a driving transistor area DTA provided in a sub-pixel SP, and illustrates an enlarged view of a first electrode E1 and a second electrode E2 portion of the driving transistor DT in comparison with FIG. 5, and FIG. 8 illustrates a cross-sectional view of the driving transistor area DTA along the line B-B′ illustrated in the plan view of FIG. 7.

As shown in FIGS. 7 and 8, an example sub-pixel SP can include a substrate 610, a shielding pattern LS disposed on the substrate 610, a buffer layer 620 disposed on the substrate 610 and the shielding pattern LS, and an active layer ACT disposed on the buffer layer 620.

The sub-pixel SP can include a gate insulating film 640 disposed on the active layer ACT and having a first opening H1, a first electrode E1 disposed to overlap with at least a portion of the gate insulating film 640, a protective layer 630 disposed on the first electrode E1, and a pixel electrode PE of a light emitting device ED disposed on the protective layer 630.

In addition, the sub-pixel SP can further include an overcoat layer 650 disposed on the protective layer 630. The sub-pixel SP can further include an auxiliary electrode 800 disposed between the active layer ACT and the first electrode E1, and the auxiliary electrode 800 can include a transparent conductive oxide.

For example, the transparent conductive oxide can include at least one of Indium Zinc Oxide (IZO), Indium Tin Oxide (ITO), Indium-Gallium-Zinc Oxide (IGZO), Zinc Oxide (ZnO), Aluminum-doped Zinc Oxide (AZO), Gallium-doped Zinc Oxide (GZO), Antimony Tin Oxide (ATO), and Fluorine-doped Transparent Oxides (FTO). In addition, one of the active layer ACT and the auxiliary electrode can include an Indium Gallium Zinc Oxide (IGZO) material, and the other can include an Indium Zinc Oxide (IZO) material, but the embodiments of the present disclosure are not limited thereto.

Also, the active layer ACT can include a channel area CH, a first area CT1 located on one side of the channel area CH, and a second area CT2 located on the other side of the channel area CH. The first electrode E1 can be electrically connected to at least a portion of the first area CT1 of the active layer ACT in the first opening H1.

In other words, the first electrode E1 can be electrically connected to the auxiliary electrode 800 and the active layer ACT in the first opening H1. Accordingly, the first opening H1 of the gate insulating film 640 can include a second connection portion CA2 through which the first electrode E1 and the first area CT1 of the active layer ACT are electrically connected.

Continuing, the first electrode E1 can be a source electrode or a drain electrode of the driving transistor DT.

The protective layer 630 is disposed on the first electrode E1, and can have a second opening H2 overlapping with at least a portion of the first electrode E1 and overlaps with at least a portion of the first opening H1.

The pixel electrode PE can be electrically connected to the first electrode E1 at the second opening H2, and can be electrically connected to the shielding pattern LS at the second opening H2.

The second opening H2 can include a first connection portion CA1 in which the pixel electrode PE and the first electrode E1 are electrically connected, and a third connection portion CA3 in which the pixel electrode PE and the shielding pattern LS are electrically connected.

Accordingly, the pixel electrode PE can be electrically connected to the first electrode E1 and the shielding pattern LS simultaneously in a single opening of the protective layer 630, i.e., at the second opening H2.

Through the first connection portion CA1, the second connection portion CA2, and the third connection portion CA3, the pixel electrode PE, the first electrode E1, the first area CT1 of the active layer ACT, and the shielding pattern LS can be electrically connected to each other to form one node, i.e., the first node N1.

For example, the node formed by the pixel electrode PE, the first electrode E1, the first area CT1 of the active layer ACT, and the shielding pattern LS can be a source node of the driving transistor DT, but the embodiments of the present disclosure are not limited thereto.

The node formed by the pixel electrode PE, the first electrode E1, the first area CT1 of the active layer ACT, and the shielding pattern LS may not overlap with the storage capacitor Cst disposed in each of the sub-pixels SP formed on the substrate.

As a variation to the device shown in FIG. 6, the first electrode E1 may be omitted to allow the pixel electrode PE to directly contact the first area CT1 of the active layer ACT. Eliminating the first electrode E1 may also be performed in the following embodiments. In various other embodiments, a layer used to create the pixel electrode PE may be patterned to also provide for an electrode directly contacting the third area CT3 of the active layer ACT.

Referring to FIG. 7, the storage capacitor Cst can overlap with the channel area CH, which in the present situation includes the second node N2 as a gate node of the driving transistor DT.

Referring to FIGS. 7 and 8, the current path C/P of the active layer ACT can be formed in an area passing through the second connection portion CA2 where the first electrode E1 and the first area CT1 of the active layer ACT are electrically connected.

In other words, the embodiments of the present disclosure can form a current path C/P of the active layer ACT in a lower area of the first electrode E1 by connecting the pixel electrode PE and the active layer ACT vertically overlapped with each other through the first electrode E1 and the auxiliary electrode 800 without directly connecting the pixel electrode PE and the active layer ACT, thereby reducing the size of the sub-pixel circuit SPC and preventing driving failure caused by high contact resistance occurring when the pixel electrode PE and the active layer ACT are directly connected.

Also, a partial areas of the buffer layer 620, the protective layer 630, the gate insulating film 640, the first electrode E1, and the active layer ACT may not overlap with the shielding pattern LS, and each of the buffer layer 620, the protective layer 630, the gate insulating film 640, the first electrode E1, and the active layer ACT can have a step in the area not overlapping overlap with the shielding pattern LS.

In other words, the sub-pixel SP can be implemented as a PAD-free structure in which the shielding pattern LS is not disposed under at least some areas of the second connection portion CA2.

Next. FIGS. 9 and 10 are diagrams illustrating another implementation example of the sub-pixel SP.

Specifically, FIG. 9 is a plan view according to another embodiment of a driving transistor area DTA provided in a sub-pixel SP, and is a drawing flipped left and right compared to the plan view of FIG. 7, and FIG. 10 is a cross-sectional view of the driving transistor area DTA along the line C-C″ illustrated in the plan view of FIG. 9.

Referring to FIGS. 9 and 10, a sub-pixel SP according to embodiments of the present disclosure can include a substrate 610, a shielding pattern LS disposed on the substrate 610, a buffer layer 620 disposed on the substrate 610 and the shielding pattern LS, and an active layer ACT disposed on the buffer layer 620.

In addition, the sub-pixel SP can include a gate insulating film 640 disposed on an active layer ACT, a first electrode E1 and a second electrode E2 disposed to overlap with at least a portion of the gate insulating film 640, a protective layer 630 disposed on the first electrode E1 and the second electrode E2, and a pixel electrode PE of a light emitting device ED disposed on the protective layer 630.

Further, the sub-pixel SP can further include an overcoat layer 650 disposed on the protective layer 630.

The sub-pixel SP can further include an auxiliary electrode 800 disposed between the active layer ACT and the first electrode E1, and the auxiliary electrode 800 can include a transparent conductive oxide.

For example, the transparent conductive oxide can include at least one of Indium Zinc Oxide (IZO), Indium Tin Oxide (ITO), Indium-Gallium-Zinc Oxide (IGZO), Zinc Oxide (ZnO), Aluminum-doped Zinc Oxide (AZO), Gallium-doped Zinc Oxide (GZO), Antimony Tin Oxide (ATO), and Fluorine-doped Transparent Oxides (FTO). In addition, auxiliary electrode can include an Indium Gallium Zinc Oxide (IGZO) material, and the other can include an Indium Zinc Oxide (IZO) material, but the embodiments of the present disclosure are not limited thereto.

In addition, the active layer ACT can include a channel area CH, a first area CT1 located on one side of the channel area CH, and a second area CT2 located on the other side of the channel area CH.

The gate insulating film 640 can include a first opening H1, and the first electrode E1 can be electrically connected to the first area CT1 in the first opening H1 and electrically connected to the shielding pattern LS.

In other words, the first opening H1 of the gate insulating film 640 can include a second connection portion CA2 in which the first electrode E1 and the first area CT1 of the active layer ACT are electrically connected, and a fourth connection portion CA4 in which the first electrode E1 is electrically connected to the shielding pattern LS.

The first electrode E1 can be disposed to be electrically connected to the first area CT1, and can be disposed to overlap with a portion of the gate insulating film 640. For example, the first electrode E1 can be a source electrode or a drain electrode of the driving transistor DT.

Referring to FIGS. 9 and 10, the second electrode E2 can be disposed to overlap with the channel area CH on the gate insulating film 640, and the second electrode E2 can extend to an area not overlapping with the active layer ACT.

For example, the second electrode E2 can be a gate electrode of a driving transistor DT.

The protective layer 630 can include a second opening H2 overlapping with at least a portion of the first electrode E1 and overlapping with at least a portion of the first opening H1.

The pixel electrode PE can be electrically connected to the first electrode E1 in the second opening H2. Further, the second opening H2 can include a first connection portion CA1 in which the pixel electrode PE and the first electrode E1 are electrically connected, and the second opening H2 can further include a second connection portion CA2 and a fourth connection portion CA4.

Accordingly, in a single opening of the protective layer 630 (i.e., the second opening H2), the pixel electrode PE can be electrically connected simultaneously with the first electrode E1, the first area CT1 of the active layer ACT, and the shielding pattern LS.

As at least a part of the first opening H1 and at least a part of the second opening H2 can overlap with each other. At least a part of the first connection portion CA1 and at least a part of the second connection portion CA2 can overlap with each other. At least a part of the first connection portion CA1 and at least a part of the fourth connection portion CA4 can overlap with each other.

Through the first connection portion CA1, the second connection portion CA2, and the fourth connection portion CA4, the pixel electrode PE, the first electrode E1, the first area CT1 of the active layer ACT, and the shielding pattern LS can be electrically connected to each other to form one node, i.e., the first node N1.

For example, a node formed by a pixel electrode PE, a first electrode E1, a first area CT1 of an active layer ACT, and a shielding pattern LS can be a source node of a driving transistor DT, but embodiments of the present disclosure are not limited thereto. A node formed by a pixel electrode PE, a first electrode E1, a first area CT1 of an active layer ACT, and a shielding pattern LS may not overlap with a storage capacitor Cst disposed in each of a plurality of sub-pixels SP.

In addition, the storage capacitor Cst can overlap with a channel area CH. In other words, the storage capacitor Cst disposed in a sub-pixel SP can overlap a gate node of a driving transistor DT, i.e., second node N2.

The second electrode E2 can be one of the capacitor electrodes constituting the storage capacitor Cst, and the pixel electrode PE can be another one of the capacitor electrodes constituting the storage capacitor Cst.

For example, the storage capacitor Cst can include the second electrode E2 as a first capacitor electrode, the pixel electrode PE adjacent to the second electrode E2 as a second capacitor electrode, and can include at least a portion of a protective layer 630 provided between the first capacitor electrode and the second capacitor electrode included as an insulator of the storage capacitor Cst.

Referring to FIGS. 9 and 10, the current path C/P of the active layer ACT can be formed in an area passing through the second connection portion CA2 where the first electrode E1 and the first area CT1 of the active layer ACT are electrically connected.

Accordingly, a current path (C/P) of the active layer ACT in a lower area of the first electrode E1 can be formed by connecting the pixel electrode PE and the active layer ACT, which are vertically overlapped with each other through the first electrode E1 and the auxiliary electrode 800, thereby reducing the size of the sub-pixel circuit SPC and preventing driving failure caused by high contact resistance occurring when the pixel electrode PE and the active layer ACT are directly connected.

Some areas of the buffer layer 620, the protective layer 630, the gate insulating film 640, the first electrode E1, and the active layer ACT may not overlap with the shielding pattern LS, and each of the buffer layer 620, the protective layer 630, the gate insulating film 640, the first electrode E1, and the active layer ACT can have a step in the area not overlapping with the shielding pattern LS.

Accordingly, the sub-pixel SP can be implemented as a PAD-free structure in which at least some areas of the second connection portion CA2 are not provided with the shielding pattern LS thereunder.

Embodiments of the present disclosure described above are briefly described as follows. A display device according to embodiments of the present disclosure can include a substrate, an active layer disposed on the substrate, and including a channel area, a first area located on one side of the channel area, and a second area located on the other side of the channel area, a gate insulating film disposed on the active layer and having a first opening, a first electrode electrically connected to at least a portion of the first area in the first opening, a second electrode disposed on the gate insulating film and overlapping with the channel area, a protective layer disposed on the first electrode and the second electrode, overlapping with at least a portion of the first electrode, and having a second opening overlapping with at least a portion of the first opening, and a pixel electrode disposed on the protective layer and electrically connected to the first electrode in the second opening. The display device can further include a shielding pattern disposed on the substrate, and a buffer layer disposed on the substrate and the shielding pattern. The shielding pattern can be electrically connected to the pixel electrode at the second opening. The pixel electrode, the first electrode, the active layer and the shielding pattern can be electrically connected to each other. The display device can further include a storage capacitor disposed on the substrate and including a plurality of capacitor electrodes. The storage capacitor may not overlap with the second opening. One of the capacitor electrodes can be the second electrode, and the other one of the capacitor electrodes can be the pixel electrode. The second electrode can extend to an area not overlapping with the channel area.

The active layer can include a peripheral area including a first connection portion where the pixel electrode and the first electrode are electrically connected, and a second connection portion where the first electrode and the first area are electrically connected. A current path in the active layer can be formed in the peripheral area. The display device can further include an auxiliary electrode disposed between the active layer and the first electrode. The auxiliary electrode can include a transparent conductive oxide.

A current path in the active layer can be formed in an area passing through a second connection portion where the first electrode and the first area are electrically connected. The first electrode can be electrically connected to the shielding pattern at the second opening. At least a portion of the second connection portion where the first electrode and the first area are electrically connected may not overlap with the shielding pattern.

The display device according to embodiments of the present disclosure can further include a light emitting device, and a driving transistor for driving the light emitting device. The first electrode can be a source electrode or a drain electrode of the driving transistor, and the second electrode can be a gate electrode of the driving transistor. The first electrode and the second electrode can be formed of the same material. The display device can further include a high-potential voltage line to which a high-potential voltage is applied; and a third electrode electrically connected between the second area and the high-potential voltage line. The first electrode, the second electrode and the third electrode can include the same material.

A display device according to embodiments of the present disclosure can include a substrate, a driving transistor disposed on the substrate, and including an active layer, a first electrode, a second electrode, and a third electrode. The display device can further include a light emitting device including a pixel electrode electrically connected to the first electrode, a common electrode facing the pixel electrode, and a storage capacitor disposed on the driving transistor. The storage capacitor can overlap a channel area of the active layer of the driving transistor.

The display device according to embodiments of the present disclosure can further include a gate insulating film disposed on the active layer and having a first opening, and a protective layer disposed on the first electrode and the second electrode with the protective layer overlapping with at least a portion of the first electrode, and having a second opening overlapping with at least a portion of the first opening. The display device can further include a pixel electrode disposed on the protective layer and connected to the first electrode, which is electrically connected at least a portion of the active layer through the first opening, in the second opening.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein can be applied to other embodiments and applications without departing from the spirit and scope of the present disclosure. The above description and the accompanying drawings provide an example of the technical idea of the present disclosure for illustrative purposes only.

What is claimed is:

1. A display device comprising:
a substrate;
a transistor on the substrate, the transistor including an active layer, wherein the active layer includes a channel area, a first area located on one side of the channel area, and a second area located on the other side of the channel area;
a gate insulating film disposed on the active layer and having a first opening;
a first electrode electrically connected to at least a portion of the first area of the active layer in the first opening;
a second electrode disposed on the gate insulating film and overlapping with the channel area;
a protective layer disposed on the first electrode and the second electrode, the protective layer overlapping with at least a portion of the first electrode and having a second opening overlapping with at least a portion of the first opening; and
a pixel electrode disposed on the protective layer and electrically connected to the first electrode in the second opening.

2. The display device of claim 1, further comprising:
a shielding pattern disposed on the substrate; and
a buffer layer disposed on the substrate and the shielding pattern.

3. The display device of claim 2, wherein the shielding pattern is electrically connected to the pixel electrode at the second opening.

4. The display device of claim 2, wherein the pixel electrode, the first electrode, the active layer and the shielding pattern are electrically connected to each other.

5. The display device of claim 1, further comprising a storage capacitor disposed on the substrate and including a plurality of capacitor electrodes,
wherein the storage capacitor does not overlap with the second opening.

6. The display device of claim 5, wherein one of the plurality of capacitor electrodes is the second electrode.

7. The display device of claim 5, wherein the other one of the plurality of capacitor electrodes is the pixel electrode.

8. The display device of claim 5, wherein the second electrode extends to an area not overlapping with the channel area.

9. The display device of claim 1, wherein the active layer includes a peripheral area including a first connection portion where the pixel electrode and the first electrode are electrically connected, and a second connection portion where the first electrode and the first area are electrically connected, and
wherein a current path in the active layer is formed in the peripheral area.

10. The display device of claim 1, further comprising an auxiliary electrode disposed between the active layer and the first electrode,
wherein the auxiliary electrode includes a transparent conductive oxide.

11. The display device of claim 10, wherein a current path in the active layer is formed in an area passing through a second connection portion where the first electrode and the first area are electrically connected.

12. The display device of claim 2, wherein the first electrode is electrically connected to the shielding pattern at the second opening.

13. The display device of claim 2, wherein the first electrode and the first area are electrically connected at a second connection portion, and
wherein at least a portion of the second connection portion where the first electrode and the first area are electrically connected does not overlap with the shielding pattern.

14. The display device of claim 1, wherein the transistor is a driving transistor for driving a light emitting device,
wherein the first electrode is a source electrode or a drain electrode of the driving transistor, and the second electrode is a gate electrode of the driving transistor, and
wherein the first electrode and the second electrode are formed of the same material.

15. The display device of claim 1, further comprising:
a high-potential voltage line to which a high-potential voltage is applied; and
a third electrode electrically connected between the second area and the high-potential voltage line.

16. The display device of claim 15, wherein the first electrode, the second electrode and the third electrode include the same material.

17. A display device comprising:
a substrate;
a driving transistor disposed on the substrate, and including an active layer, a first electrode, a second electrode, and a third electrode;
a light emitting device including a pixel electrode electrically connected to the first electrode, and a common electrode facing the pixel electrode; and
a storage capacitor disposed on the driving transistor, and overlapping with a channel area of the active layer of the driving transistor.

18. The display device of claim 17, further comprising:
a gate insulating film disposed on the active layer and having a first opening;
a protective layer disposed on the first electrode and the second electrode, overlapping with at least a portion of the first electrode, and having a second opening overlapping with at least a portion of the first opening; and
a pixel electrode disposed on the protective layer and connected to the first electrode, which is electrically connected at least a portion of the active layer through the first opening, in the second opening.

19. A display device comprising:
a substrate;
a light shield disposed on the substrate;
a transistor disposed on and overlapping the light shield in plan view, the transistor including an active layer including a channel area overlapping the light shield, a first area located on one side of the channel area, and a second area located on the other side of the channel area;
a first electrode electrically connected to the first area, a second electrode overlapping the channel area, and a third electrode electrically connected to the second area; and
a light emitting device including a common electrode connected to a first power voltage line applying a first power voltage, a pixel electrode, and a light emitting element disposed between the common electrode and the pixel electrode,
wherein the pixel electrode includes an integrally-formed portion overlapping the second electrode to form a storage capacitor, directly contacts the first electrode, and overlaps the common electrode and light emitting element in plan view.

20. The display device of claim 19, further comprising:
an insulating film between the light shield and the channel area;
a gate insulating film between the second electrode and the active layer including a first hole; and
an insulating layer between the pixel electrode and the second electrode including a second hole overlapping the first hole in plan view,
wherein the first hole and the second hole overlap at a location directly above the light shield.
